(19) United States
(12) Patent Application Publication
(10) Pub. No.: US 2026/0261399 A1
(43) Pub. Date: Sep. 3, 2026

(54) SYSTEMS AND METHODS FOR HOMOMORPHIC-ENCRYPTION-SUPPORTED PROVISIONING OF SECURE DEVICES

(71) Applicant: ASSA ABLOY AB, Stockholm (SE)

(72) Inventors: Adam Augustyn, Krzeszowice (PL); Krzysztof Grzegorz Fabjanski, Bielsko-Biala (PL); Andrzej Bohdan Kostyk, Wieliczka (PL)

(21) Appl. No.: 18/869,515

(22) PCT Filed: Jun. 13, 2022
(86) PCT No.: PCT/EP2022/066000

§ 371 Date: Nov. 26, 2024

(51) Int. Cl. H04L 9/00; H04L 9/08

(52) U.S. Cl. CPC H04L 9/008; H04L 9/0861

(57) ABSTRACT

Disclosed herein are systems and methods for homomorphic-encryption-supported provisioning of secure devices. In an embodiment, a provisioning server (e.g., a cloud-based provisioning server) receives a request, associated with (e.g., from) a secure device (e.g., a keycard), for a homomorphically encrypted diversified key that is based on (e.g., derived from) a master key of an encryption system. The secure device stores a copy of a homomorphic-encryption key. The provisioning server derives a homomorphically encrypted diversified key from a homomorphically encrypted master key, which is the master key previously encrypted with the homomorphic-encryption key. The provisioning server transmits the homomorphically encrypted diversified key to the secure device. The secure device may then be operable to access at least one resource using a diversified master key, which is the homomorphically encrypted diversified key after having been decrypted on the secure device using its stored copy of the homomorphic-encryption key.

### TECHNICAL FIELD

Among other technical fields, embodiments of the present disclosure pertain to encryption, symmetric encryption, homomorphic encryption, cloud computing, secure devices (e.g., keycards), access control systems (including physical, electronic, logical, etc. access control systems), and, more particularly, to systems and methods for homomorphic-encryption-supported provisioning of secure devices.

### BACKGROUND

Security is an ever-increasing concern in today's modern world. This concern extends to, among other areas of life, security related to protecting physical spaces such as homes, offices, labs, engineering facilities, hospitals, and so forth. In a typical arrangement, and using a lab as an example physical space, the lab may be protected by what is known in the art as a physical access control system (PACS) or electronic access control system (EACS), among other possibilities. In an example situation, there may only be one door to the lab (perhaps in addition to windows for fire safety, etc.), and that door may be protected by a locking mechanism that is controlled by a keycard reader that is proximate the door.

In operation, an authorized user may bring their keycard close enough to the reader to activate wireless (e.g., radio frequency (RF)) communication in which the reader sends a challenge to the keycard, which is energized and activated by that received energy to respond with a credential for processing by the reader and/or a connected system. Assuming proper authorization, the reader may responsively unlock the door, which may then automatically close and lock on its own. It is noted that, in the present disclosure, the term “credential” is used broadly to encompass any set of one or more values that are provided for access to—or activation of, etc.—a given resource, be it a physical space as in the aforementioned lab example, an electronic resource (e.g., a given computing terminal, a given network server, a given online account (e.g., bank account), and/or the like), and/or one or more other protected resources.

### BRIEF DESCRIPTION OF THE DRAWINGS

A more detailed understanding may be had from the following description, which is presented by way of example in conjunction with the following drawings, in which like reference numerals are used across the drawings in connection with like elements.

FIG. 1 depicts an example security arrangement in which at least one embodiment may be carried out.

FIG. 2 depicts a first example information-flow diagram, in which a provisioning process for a secure device includes performance of a key derivation function in a hardware security module.

FIG. 3 depicts an example method of secure-device provisioning, in accordance with at least one embodiment.

FIG. 4 depicts a second example information-flow diagram, in which a provisioning process for a secure device includes performance of a key derivation function in a provisioning server operating on a homomorphically encrypted master key, in accordance with at least one embodiment.

FIG. 5 depicts an example encrypted-key table, in accordance with at least one embodiment.

FIG. 6 depicts an example computer system that may be utilized in accordance with at least one embodiment.

### DETAILED DESCRIPTION

Disclosed herein are embodiments of systems and methods for homomorphic-encryption-supported provisioning of secure devices. One embodiment takes the form of a method that is performed by a provisioning server executing instructions on at least one hardware processor. The method includes the provisioning server receiving a request, associated with a secure device, for a homomorphically encrypted diversified key that is based on a master key of an encryption system. The secure device has stored thereon a copy of a homomorphic-encryption key. The provisioning server derives a homomorphically encrypted diversified key from a homomorphically encrypted master key, which is the master key previously encrypted with the homomorphic-encryption key. The provisioning server transmits the homomorphically encrypted diversified key to the secure device. In at least some embodiments, the secure device may then decrypt the homomorphically encrypted diversified key using the secure device's copy of the homomorphic-encryption key. The diversified encryption key may then be encoded on (e.g., stored by) the secure device.

As described herein, one or more embodiments of the present disclosure take the form of methods that include multiple operations. One or more other embodiments take the form of systems that include at least one hardware processor and that also include one or more non-transitory computer-readable storage media containing instructions that, when executed by the at least one hardware processor, cause the at least one hardware processor to perform multiple operations (that in some embodiments do and in other embodiments do not correspond to operations performed in a herein-disclosed method embodiment). Still one or more other embodiments take the form of one or more non-transitory computer-readable storage media (CRM) containing instructions that, when executed by at least one hardware processor, cause the at least one hardware processor to perform multiple operations (that, similarly, in some embodiments do and in other embodiments do not correspond to operations performed in a herein-disclosed method embodiment and/or operations performed by a herein-disclosed system embodiment).

Furthermore, a number of variations and permutations of embodiments are described herein, and it is expressly noted that any variation or permutation that is described in this disclosure can be implemented with respect to any type of embodiment. For example, a variation or permutation that is primarily described in this disclosure in connection with a method embodiment could just as well or instead be implemented in connection with a system embodiment and/or a CRM embodiment. Furthermore, this flexibility and cross-applicability of embodiments is present in spite of any slightly different language (e.g., processes, methods, methodologies, steps, operations, functions, and/or the like) that is used to describe and/or characterize such embodiments and/or any element or elements thereof.

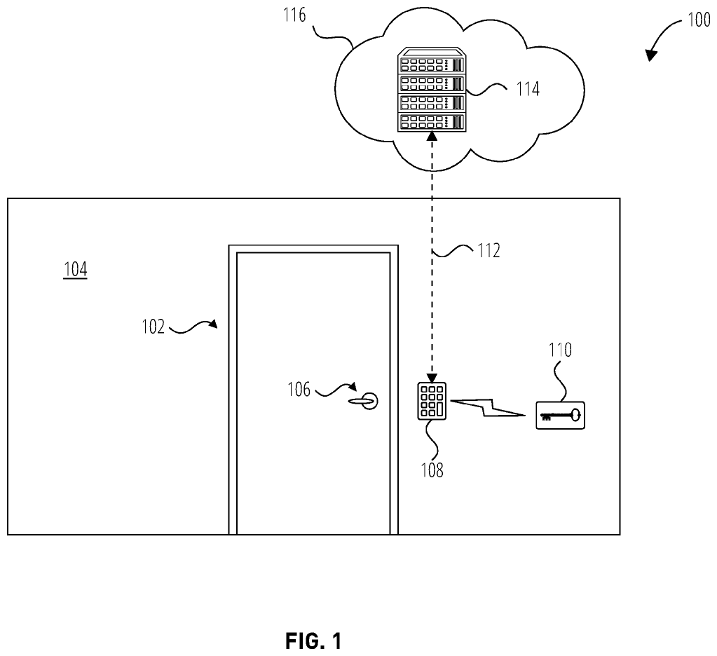

FIG. 1 shows an example security arrangement 100 that may be used in connection with at least some embodiments of the present disclosure. As a general matter, the examples that are provided in the present disclosure largely involve using a secure device such as a keycard (or “access card,” etc.) to gain access to a physical resource such as a lab. It should be understood, however, that this is purely for clarity of presentation and by way of example. One or more of the various embodiments that are described herein may be applied to other secure devices, in connection with access to (and/or activation of, etc.) one or more different physical and/or electronic (e.g., computing) resources, logical resources, and/or the like. As examples, one or more of the various embodiments of the present disclosure could be applied to an EACS, a logical access control system (LACS), and/or the like. Additional and/or different applications may occur to those of skill in the art having the benefit of the present disclosure.

As can be seen in FIG. 1, in the example security arrangement 100, a door 102 is disposed on a wall 104, behind which may be a protected resource. In the present example, that protected resource is a lab. The door 102 has disposed thereon a handle 106, which in this example is equipped with a locking mechanism (not explicitly depicted) that is controlled by a reader 108. In the depicted scenario, the reader 108 is positioned proximate the door 102, and in particular is positioned proximate the handle 106 of the door 102. The handle 106 may have at least a locked state and an unlocked state. The reader 108 may have stored therein a copy of a master key, which may be particular to the door 102 (i.e., to the reader 108), or which may be more broadly associated with multiple readers.

In an example scenario, the handle 106 is in the locked state in its default mode of operation, and the reader 108 is operable to selectively place the handle 106 in the unlocked state responsive to being presented with an authorized credential by a secure device such as the example keycard 110 that is depicted in FIG. 1. As described above, in an example scenario, the reader 108 and the keycard 110 may communicate wirelessly with one another responsive to the keycard 110 being brought close enough to the reader 108 to initiate an activation sequence. Wireless energy emitted from the reader 108 may energize and activate one or more circuit elements in the keycard 110, causing the keycard 110 to emit RF information for receipt by the reader 108. In a typical scenario, a secure session (or secure connection, among other terms that could be used) may be established between the reader 108 and the keycard 110. Such a secure session may be established using a challenge-response-type protocol, and may be conducted according to secure socket layer (SSL), transport layer security (TLS), mutual authentication, or another suitable protocol or type of session. In an example scenario, the secure session is established based on a symmetric session key.

The keycard 110 may have stored thereon a credential. For example, the credential may be a diversified key that had been derived from the abovementioned master key that is stored in the reader 108. This master key may also be stored in another entity of the associated encryption system, such as a hardware security module for example. The keycard 110 may transmit this diversified key to the reader 108 along with what is known as a diversification value (or “diversifier”). The reader 108 may then dynamically use its copy of the master key and the diversification value received from the keycard 110 to compute a diversified key of its own, which the reader 108 may then compare with the diversified key that the reader 108 received from the keycard 110. In the case of a match, access may be granted. In this example, the reader 108 may place the handle 106 in its unlocked state so that the bearer of the keycard 110 can pass through the door 102. If there is not a match, the reader 108 may simply do nothing, may issue a follow-up message to the keycard 110 to give the keycard 110 another chance, or some other response (or lack of response) deemed suitable by those of skill in the art for a given implementation. In some scenarios, the reader 108 may keep a stored table of diversification values associated with corresponding diversified keys, though this may be considered less secure than the above-described “on-the-fly” calculation of the diversified key by the reader 108.

In some arrangements, the reader 108 itself may locally determine whether or not to grant access. In other arrangements, the reader 108 may consult an access server 114 (and/or other entity, device, system, etc.) via a communication link 112 in making a decision to grant or deny access. The communication link 112 may include one or more wired-communication links and/or one or more wireless-communication links, as deemed suitable by those of skill in the art for a given implementation and/or in a given context. The access server 114 may include one or more devices, and may be part of (and/or resident in, etc.) a cloud system 116, as an example. In some instances, an onsite controller may be queried by the reader 108 as part of determining whether to grant or deny access to a given resource. Other arrangements are possible as well.

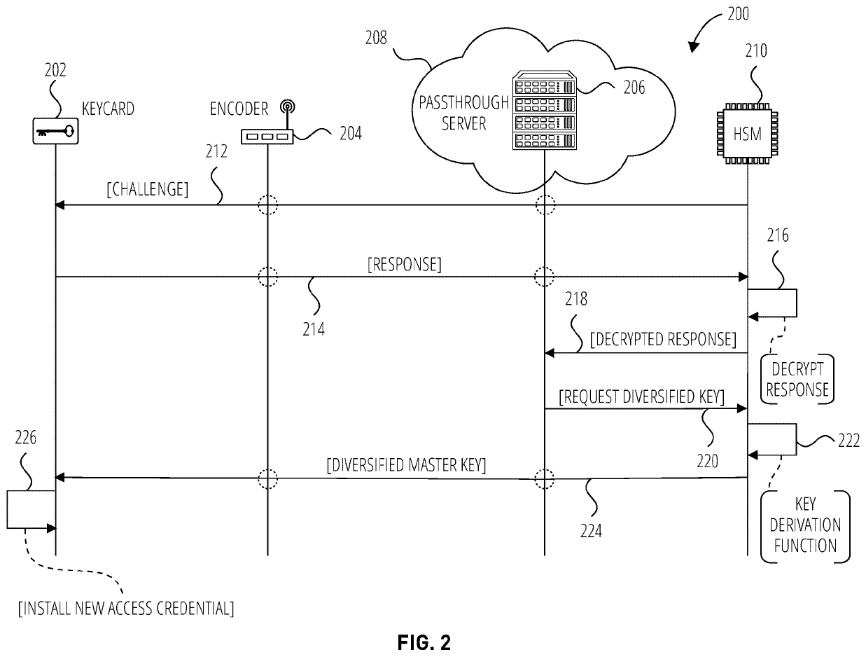

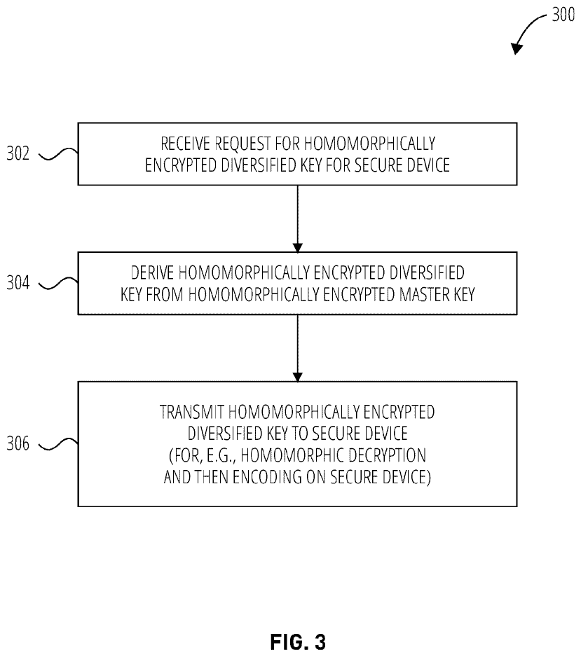

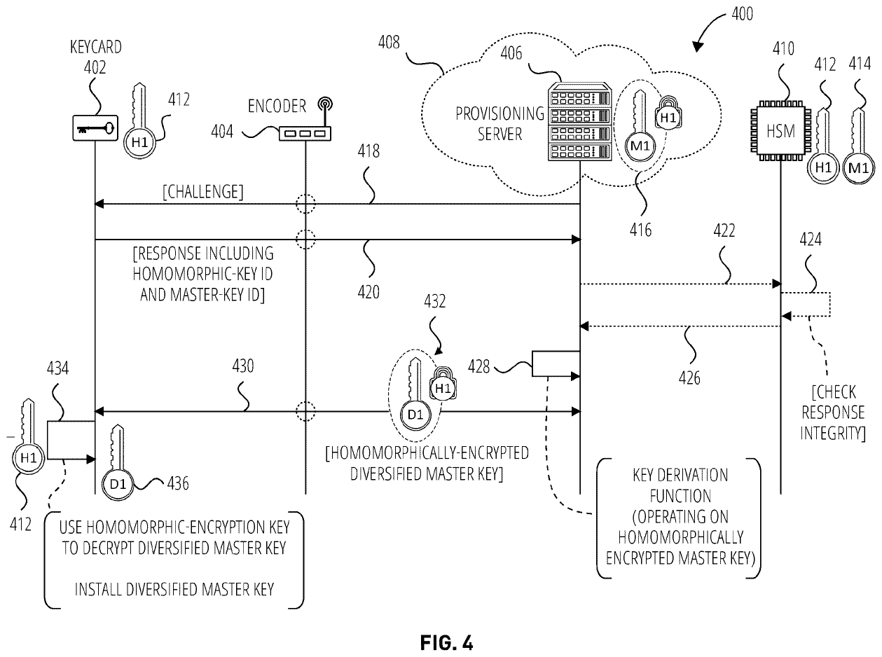

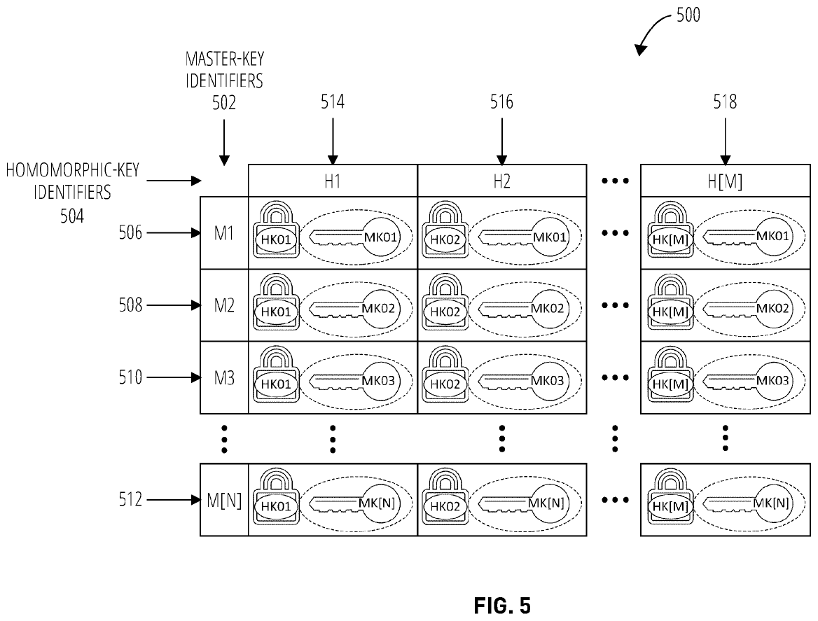

Prior to being used in connection with an attempt to gain access to the example lab, and from time to time thereafter, the keycard 110 may undergo a provisioning process by which the aforementioned credential is stored on the keycard 110. Several ways in which this provisioning could occur are described herein. One way, used in some conventional systems, is described below in connection with FIG. 2. A second way, usable in one or more systems in accordance with embodiments of the present disclosure, is described below in connection with FIG. 3, FIG. 4, and FIG. 5, along with numerous variations, embodiments, permutations, and the like thereof. Moreover, it should be understood that keycards are described in the present disclosure by way of example, and that other secure devices could be used instead or in addition. Some example secure devices include fobs, mobile devices (e.g., smartphones), Universal Serial Bus (USB) devices (e.g., dongles), and/or the like.

In various different embodiments, a given secure device (e.g., a keycard) may include what is known in the art as a secure element for storage of confidential data, for conducting certain cryptographic methods (e.g., operations), and/or the like. Readers such as the reader 108 may also include a secure element for safe storage of the master key, among other purposes. Moreover, in embodiments in which a remote access server, onsite controller, and/or the like is utilized, such an access server (or controller, etc.) could perform one or more functions for the reader 108 such as authorization, authentication, and/or the like. Moreover, as stated above, in some embodiments, the reader 108 performs such functions locally, in some embodiments as a standalone unit, in other embodiments involving communication with one or more other devices, systems, servers, and/or the like via a local area network (LAN), a wide area network (WAN), and/or the like, as examples.

FIG. 2 illustrates an example information-flow diagram 200 for provisioning a secure device. As referenced above, the information-flow diagram 200 depicts a sequence of messaging, operations, and the like that may be utilized in a conventional system (e.g., a conventional PACS). Prior to proceeding with this description of FIG. 2, it is noted that, in both FIG. 2 and FIG. 4, which is described below, secure messaging may be used for one, some, or all of the depicted communications. To simplify the presentation of both FIG. 2 and FIG. 4, session keys (e.g., ephemeral session keys) are not explicitly depicted. In some embodiments, ephemeral symmetric encryption keys are utilized for the depicted communications.

Turning now to FIG. 2, it can be seen that the communications and operations that are depicted in and described in connection with the information-flow diagram 200 involve an example keycard 202, an example encoder 204, an example passthrough server 206 that may be resident in an example cloud system 208, and an example hardware security module 210. The encoder 204 is depicted generically as a wireless access point (or other device capable of wireless communication), and could be a dedicated keycard encoder, a smartphone, and/or any other device or system deemed suitable by those of skill in the art for a given implementation. In some cases, the encoder 204 may be or include a reader such as the reader 108.

As shown in the information-flow diagram 200, the hardware security module 210 issues a challenge 212 to the keycard 202 via both the passthrough server 206 and the encoder 204. The keycard 202 responds by transmitting a response 214 back to the hardware security module 210 via both the encoder 204 and the passthrough server 206. In FIG. 2 (and in FIG. 4), a dashed circle is used to indicate instances in which information passes through a given device, system, or the like without being, as examples, changed, decrypted, and/or the like. Essentially, the dashed circles indicate passthrough events with respect to the corresponding messaging and device. The challenge 212 and the response 214 are presented to represent the establishment of a secure session (using, e.g., symmetric encryption) between the keycard 202 and the hardware security module 210.

In this example, the response 214 is encrypted by the keycard 202 using an ephemeral symmetric session key. Upon receipt of the response 214, the hardware security module 210 uses its copy of that session key to perform a decryption 216 of the response 214. The hardware security module 210 then transmits a decrypted response 218 to the passthrough server 206, which turns around and sends a diversified-key request 220 back to the hardware security module 210. In this example, the passthrough server 206 is requesting that the hardware security module 210 generate a diversified key for the keycard 202 to use as a credential.

The hardware security module 210 may carry out a key derivation function 222 in order to generate the requested new access credential for the keycard 202. Upon generation of the requested diversified master key 224, the hardware security module 210 may pass that diversified master key 224 to the keycard 202. In some cases, the hardware security module 210 may pass the diversified master key 224 to the encoder 204 for the encoder 204 to then transmit the diversified master key 224 to the keycard 202. In an example scenario, the keycard 202 may use its copy of the aforementioned ephemeral symmetric session key to decipher the secure message received from the hardware security module 210. The keycard 202 may then conduct a credential installation 226 in which the keycard 202 stores the decrypted new access credential on the keycard 202 for later use (in, e.g., one or more access attempts with respect to one or more protected resources).

It can be seen in FIG. 2 that, according to the example information-flow diagram 200, the hardware security module 210 is burdened with receipt of the response 214, performing the decryption 216, transmitting the decrypted response 218, receiving the diversified-key request 220, performing the key derivation function 222, and transmitting the diversified master key 224. It is noted that the key derivation function 222 is often a particularly burdensome calculation, and that the hardware security module 210 is a limited resource. Moreover, it is further noted that approaches such as or similar to that depicted in the information-flow diagram 200 of FIG. 2 often involve making customized changes to a given hardware security module, which can compromise the certification status of that device, among other problems. One example of such a customized change that could “break” the certification of a given hardware security module is a non-certified KDF that is implemented on top of one or more of the existing cryptographic methods of the given hardware security module. Other examples could be listed here as well.

As mentioned above, the example information-flow diagram 200 of FIG. 2 depicts an information flow in which the keycard 202 is provisioned according to a process that involves the key derivation function 222 being performed in the hardware security module 210. In that key derivation function 222, the hardware security module 210 operates on unencrypted data, though it does so safely within the confines of the hardware security module 210. This paradigm, however, places an excessive burden on the hardware security module 210, in that it must conduct the key derivation function 222 every time a keycard is provisioned (or re-provisioned, etc.). This approach is both monetarily and computationally expensive, and suffers from a lack of scalability, among other issues.

In accordance with embodiments of the present disclosure, a provisioning process with respect to a given secure device (e.g., keycard) still involves a key derivation function, but one that is executed by a provisioning server outside of the relevant hardware security module. Moreover, instead of operating on unencrypted data (like the example hardware security module 210 does in the information-flow diagram 200), the provisioning server operates on encrypted data. In particular, the provisioning server conducts a key derivation function in which the inputs are (or at least include) (i) a homomorphically encrypted master key and (ii) a diversification value. Due to the characteristics of homomorphic encryption, the result of this key derivation function is a homomorphically encrypted diversified master key, which can then be transmitted to the relevant keycard. In embodiments of the present disclosure, the keycard has its own copy of the relevant homomorphic key, such that the keycard is able to remove the homomorphic encryption, resulting in the keycard then having a copy of the diversified master key for the keycard to present to devices such as readers and/or the like.

Examples of embodiments of the present disclosure are described below in connection with FIG. 3, FIG. 4, and FIG. 5. In particular, FIG. 3 depicts an example method 300 of secure-device provisioning, and is described below in connection with both FIG. 4, which depicts an example information-flow diagram 400, and FIG. 5, which depicts an example encrypted-key table 500. By way of example, the method 300 is described herein as being performed by a provisioning server 406 that is depicted in FIG. 4, though the method 300 could be performed by any set of one or more computing devices that are suitably programmed to perform the herein-described operations.

As referenced above, the information-flow diagram 400 depicts a sequence of messaging, operations, and the like that may be utilized for provisioning a secure device in connection with embodiments of the present disclosure. As can be seen in FIG. 4, the communication and operations that are depicted in and described in connection with the information-flow diagram 400 involve an example keycard 402, an example encoder 404, the abovementioned example provisioning server 406 (which may be resident in an example cloud system 408), and an example (and optional) hardware security module 410.

To further set the stage for this combined description of FIG. 3, FIG. 4, and FIG. 5, a few preliminary steps are presumed to have already happened:
First, a set of three values has been stored on the keycard 402:
   a homomorphic-encryption key 412;
   a data value that is referred to herein as a homomorphic-key identifier; and
   a data value that is referred to herein as a master-key identifier.
Second, the hardware security module 410 has been securely populated with:
   the same homomorphic-encryption key 412 that is stored in the keycard 402; and
   a master key 414.
Third, inside the hardware security module 410, the master key 414 has been encrypted with the homomorphic-encryption key 412, generating what is referred to herein as a homomorphically encrypted master key 416.
Fourth, the homomorphically encrypted master key 416 has been stored in a data storage (not explicitly depicted in FIG. 4) that is external to the hardware security module 410, and that is accessible to the provisioning server 406.

It is noted that, as described more fully below, some embodiments of the present disclosure involve encryption systems having multiple different master keys and/or multiple different homomorphic-encryption keys, among other possible variations. In at least one embodiment, an encryption system includes a different homomorphic key for each secure device (e.g., for each keycard). In other embodiments, various different homomorphic-encryption keys may be associated with sets of secure devices (e.g., with sets of keycards). Each reader in a given encryption system could be associated with a different master key, or various different sets of readers could be associated with respective master keys. Numerous other implementation choices are possible as well.

As described above, in some embodiments, the homomorphic encryption of the master key 414 using the homomorphic-encryption key 412 is conducted inside the hardware security module 410 to generate the homomorphically encrypted master key 416. In other embodiments, this encryption could be carried out in a different type of secure environment, such as a secure enclave, for example. Other options could be utilized instead and/or as well.

Turning momentarily to FIG. 3, the operations of the method 300 in embodiments of the present disclosure are described in turn below. Prior to or as an initial step in performing the method 300, the provisioning server 406 may transmit a challenge 418 to the keycard 402 via the encoder 404, which may function as a passthrough proxy device for communications between the keycard 402 and the provisioning server 406. The sending of the challenge 418 may be an initial step in establishing a secure session between the keycard 402 and the provisioning server 406. As mentioned above, any ephemeral session keys associated with such a secure session are not explicitly depicted in FIG. 4.

At operation 302, the provisioning server 406 receives a request 420 from the keycard 402 in response to the challenge 418. The request 420 may include information for establishing a secure session between the keycard 402 and the provisioning server 406. Moreover, it is noted that, for brevity and clarity of presentation, it is not mentioned in this description in connection with every communication that the given communication passes from sender to ultimate receiver via one or more intermediate entities or devices such as the encoder 404. Moreover, similar to the encoder 204, the encoder 404 is depicted as a wireless access point (or other device capable of wireless communication), and could be a dedicated keycard encoder, a smartphone, and/or any other device or system deemed suitable by those of skill in the art for a given implementation. In some cases, the encoder 404 may be or include a reader such as the reader 108.

Furthermore, the request 420 is associated with the keycard 402, and in this example comes from the keycard 402 itself. In some embodiments, a provisioning request associated with a given secure device (e.g., the keycard 402) may be sent to the provisioning server 406 by another entity (e.g., a reader, an encoder, another server, and/or the like). The request 420 is a request for a credential for the keycard 402 to use following the provisioning process.

In this example, the credential that is being requested for (and in this case by) the keycard 402 is a homomorphically encrypted diversified key. In particular, what is being requested is a homomorphically encrypted diversified key that is based on (e.g., derived from) the master key 414. In embodiments of the present disclosure, the master key 414 may be stored in a reader (e.g., the reader 108) and in the hardware security module 410. In some embodiments, the master key 414 is not stored (in an unencrypted form) in any other entity in the associated system. Moreover, as stated above, in at least some embodiments, the keycard 402 has stored thereon a copy of the homomorphic-encryption key 412, which is further discussed below. In addition, the keycard 402 has stored thereon (i) a master-key identifier that corresponds to the master key 414 and (ii) a homomorphic-key identifier that corresponds to the homomorphic-encryption key 412.

It is noted that, in embodiments other than those described here in connection with FIG. 4 and FIG. 5, an encryption system could have just one master key, in which case it would not be necessary for a secure device to identify which master key was associated with its credential request. In some such embodiments and in others, an encryption system could have just one homomorphic-encryption key, in which case it would not be necessary for a secure device to identify which homomorphic-encryption key was associated with its credential request. Such are design choices. In the present description, however, embodiments are described in connection with an encryption system that includes multiple different master keys and multiple different homomorphic-encryption keys; as such, in the associated described embodiments, the secure device specifies both a master key and a homomorphic-encryption key using a master-key identifier and a homomorphic-key identifier, respectively.

In the present example, the provisioning server 406 has access to a secure database within which is stored a number of homomorphically encrypted master keys, each of which is accessible by providing (i) the master-key identifier of the associated master key and (ii) the homomorphic-key identifier of the homomorphic-encryption key used to homomorphically encrypt that particular instance of the associated master key. One way in which such data could be organized is shown as the example encrypted-key table 500 of FIG. 5.

It can be seen in FIG. 5 that the encrypted-key table 500 is a two-dimensional table having multiple rows and multiple columns. The rows 506, 508, and 510 through 512 correspond respectively with different master-key identifiers 502. The columns 514 and 516 through 518 correspond respectively to different homomorphic-key identifiers 504. As can be seen by the various horizontal and vertical ellipses that are depicted in FIG. 5, the encrypted-key table 500 may contain any suitable number of rows corresponding respectively to master-key identifiers 502, as well as any suitable number of columns corresponding respectively to homomorphic-key identifiers 504. The master-key identifiers 502 are {M1, M2, M3, . . . , M[N]}, indicating an arbitrary number N of master-key identifiers 502 in the encrypted-key table 500. The homomorphic-key identifiers 504 are indicated as {H1, H2, . . . , H[M]}, indicating an arbitrary number M of homomorphic-key identifiers 504 in the encrypted-key table 500. N and M could be equal to or different from one another.

In each cell of the encrypted-key table 500, it is represented that there is a copy of a given one of the master keys encrypted with a given one of the homomorphic-encryption keys. Thus, each of the cells of the encrypted-key table 500 contains what is referred to in the present disclosure as a “homomorphically encrypted master key.” As an example, the row 506 corresponds to a master-key identifier “M1” and a master key “MK01,” and the column 514 corresponds to a homomorphic-key identifier “H1” and a homomorphic-encryption key “HK01.” Accordingly, the intersection of the row 506 and the column 514 is a cell that could be referred to as “M1H1,” and that contains a homomorphically encrypted master key that is the result of encrypting master key “MK01” with homomorphic-encryption key “HK01.” This is represented by a lock icon labeled “HK01” abutting a dashed oval containing a key icon labeled “MK01.” A similar description could be given of each of the other cells in the encrypted-key table 500.

Returning to FIG. 4, in at least one embodiment, the request 420 includes both a master-key identifier and a homomorphic-key identifier. In this example, those identifiers are “M1” and “H1,” respectively. It is noted that the identifiers could be integers or take any other suitable form, and that the notation such as “M1,” “H1,” and the like are used in the present disclosure as representative symbols. Similarly, the various keys could be numbers in binary, octal, decimal, hexadecimal, and/or any other suitable format, or could be alphanumeric strings or take some other form, and the notation such as “MK01,” “HK01,” and the like are used in the present disclosure as representative symbols.

In at least one embodiment, upon receiving the request 420, the provisioning server 406 verifies the integrity of the request 420 by communicating with the hardware security module 410. In one example, the provisioning server 406 may send the request 420 to the hardware security module 410 as an integrity-check request 422. The hardware security module 410 may then conduct an integrity check 424 with respect to the request 420, to verify the integrity of that message. For example, the hardware security module 410 may verify a digital signature, verify an error-correction-related value (e.g., checksum, cyclic redundancy check (CRC), and/or the like), and/or perform one or more other integrity checks of the request 420. Generally stated, the integrity check 424 may involve the hardware security module 410 verifying whether the request 420 is a valid cryptogram.

Upon completion of the integrity check 424, the hardware security module 410 may transmit an integrity-check response 426 to the provisioning server 406, indicating the result of the integrity check 424. The optional nature of the integrity-check request 422, the integrity check 424, and the integrity-check response 426 are indicated using dotted arrows in FIG. 4. It is noted that the hardware security module 410 could, but need not, be resident in the cloud system 408. In some embodiments, the hardware security module 410 is not resident in the cloud system 408 but is nonetheless accessible to the provisioning server 406. In some embodiments, the hardware security module 410 is not present, in accordance with the fact that some embodiments involve provisioning processes that themselves do not involve a hardware security module.

Whether or not an integrity check 424 is conducted with reference to the hardware security module 410, the provisioning server 406 may, following receipt of the request 420, use the included master-key identifier “M1” and homomorphic-key identifier “H1” to retrieve the cryptogram that is the master key “MK01” after having been encrypted using the homomorphic-encryption key “HK01.” With respect to corresponding to FIG. 4:
the master key “MK01” (as identified by the master-key identifier “M1”) represents the master key 414;
the homomorphic-encryption key “HK01” (as identified by the homomorphic-key identifier “H1”) represents the homomorphic-encryption key 412; and
the cryptogram in cell “M1H1” corresponds to the homomorphically encrypted master key 416.

In some embodiments, a single identifier may be provided in the request 420 and be used to retrieve a homomorphically encrypted master key from data storage. And certainly numerous other arrangements for storage and access of homomorphically encrypted master keys could be used as well. In at least one embodiment, the homomorphically encrypted master keys are encrypted at rest in the data store, which could be a “not only SQL” (i.e., “NoSQL”) database, as one example.

At operation 304, the provisioning server 406 derives a homomorphically encrypted diversified key from the homomorphically encrypted master key 416. In the example shown in FIG. 4, the provisioning server 406 conducts a key derivation function 428 to derive a homomorphically encrypted diversified master key 432 from the homomorphically encrypted master key 416. The key derivation function 428 may involve a series of iteratively performed mathematical operations such as addition, subtraction, multiplication, division, concatenation, and/or the like. In some embodiments, a diversification value from the request 420 is also included as in input to the key derivation function 428. Because of the nature and properties of homomorphic encryption, the key derivation function 428 can be performed outside of the hardware security module 410 on already encrypted material, freeing up the hardware security module 410 from having to be involved in the provisioning process, and in particular freeing up the hardware security module 410 from being utilized for performing a key derivation function.

At operation 306, the provisioning server 406 transmits the homomorphically encrypted diversified master key 432 to the keycard 402. In some embodiments, the provisioning server 406 may do this by transmitting the homomorphically encrypted diversified master key 432 to the encoder 404 for the encoder 404 to then transmit the homomorphically encrypted diversified master key 432 to the keycard 402. These communications, like the others described herein, may be conducted using secure messaging; for example, the homomorphically encrypted diversified master key 432 may be included in a secure message 430 that is transmitted by the provisioning server 406.

Upon receipt of the homomorphically encrypted diversified master key 432, the keycard 402 may conduct a homomorphic decryption and credential installation 434. This may include the keycard 402 decrypting the homomorphically encrypted diversified master key 432 using the local copy of the homomorphic-encryption key 412, resulting in a diversified master key 436, which the keycard 402 may store thereon (in, e.g., a secure element) for later use in accessing one or more resources. The decryption using the homomorphic-encryption key 412 is indicated by a “-” sign to the left of the homomorphic-encryption key 412 near the homomorphic decryption and credential installation 434.

Thereafter, as an example, the keycard 402 may present the diversified master key 436 to the reader 108 for access through the door 102. It is noted that, in at least one embodiment, if the key derivation function 428 was conducted on the (cleartext) master key 414, the result would be the diversified master key 436. Indeed, among the benefits of embodiments of the present disclosure is that the same keys and readers that are used in connection with an implementation similar to the information-flow diagram 200 of FIG. 2 can be used in connection with an implementation that uses the approach shown in and described in connection with the method 300 of FIG. 3 and the information-flow diagram 400 of FIG. 4. That is, in many cases, implementation of embodiments of the present disclosure does not necessitate wholesale changes to a given PACS.

Moreover, embodiments of the present disclosure are advantageous as compared with approaches similar to the approach of the information-flow diagram 200 of FIG. 2 in that approaches similar to the method 300 of FIG. 3 and the information-flow diagram 400 of FIG. 4 place a significantly lower burden on the hardware security module 410 than is placed on the hardware security module 210 in that type of implementation. Visual comparison of FIG. 2 with FIG. 4 is enough to demonstrate that the hardware security module 410 is, in at least one embodiment, only being asked to do a simple operation to verify that the integrity-check request 422 is a valid cryptogram, and is not being asked to carry out any one or more KDFs. Indeed, due to the use of homomorphic encryption in embodiments of the present disclosure, the more burdensome KDF-type calculations are performed on encrypted material outside of the hardware security module 410, all without ever exposing the underlying encrypted key material in plaintext.

Among many other additional advantages that could be listed here, embodiments of the present disclosure therefore simplify secure-device provisioning, improve the post-manufacturing processes related to the secure devices, reduce the burden of setup and utilization of the relevant hardware security module (if used at all), and perform the more computation-intensive operations using cloud-computing resources rather than the much more limited (and expensive) hardware-security-module computing resources. Cloud-computing resources are typically significantly more powerful and elastic than hardware-security-module computing resources, but are also significantly less secure as a general matter. The latter issue is mitigated to a large extent in embodiments of the present disclosure by the use of homomorphic encryption, which permits computation-intensive operations to be performed outside of the hardware security module on encrypted material rather than inside the hardware security module on plaintext material, and further enables storage of homomorphically-encrypted master keys in databases having appropriate levels of security. And certainly many other advantages could be listed here as well and will occur to those of skill in the art having the benefit of the present disclosure.

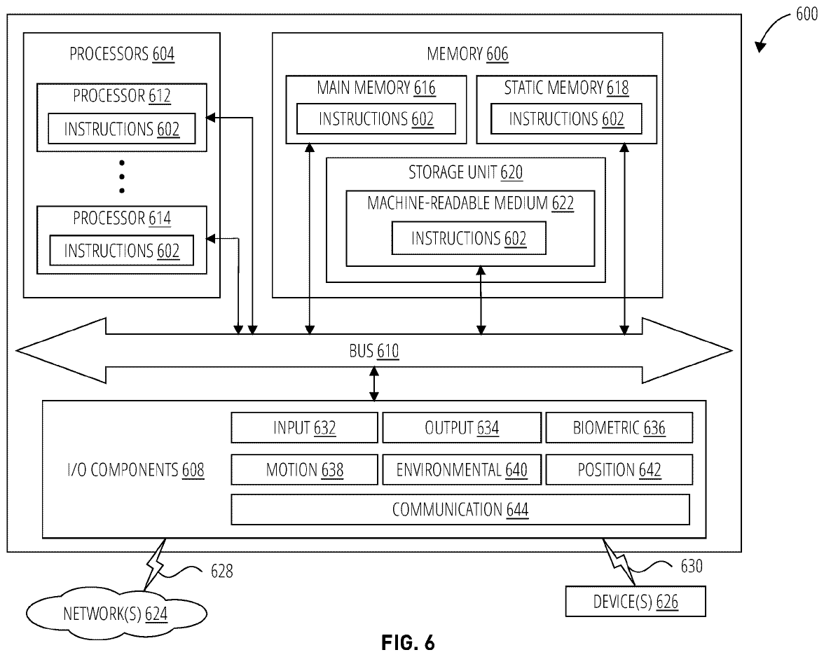

FIG. 6 depicts an example computer system 600 within which instructions 602 (e.g., software, firmware, a program, an application, an applet, an app, a script, a macro, and/or other executable code) for causing the computer system 600 to perform any one or more of the methodologies discussed herein may be executed. In at least one embodiment, execution of the instructions 602 causes the computer system 600 to perform one or more of the methods described herein. In at least one embodiment, the instructions 602 transform a general, non-programmed computer system into a particular computer system 600 programmed to carry out the described and illustrated functions. The computer system 600 may operate as a standalone device or may be coupled (e.g., networked) to and/or with one or more other devices, machines, systems, and/or the like. In a networked deployment, the computer system 600 may operate in the capacity of a server and/or a client in one or more server-client relationships, and/or as one or more peers in a peer-to-peer (or distributed) network environment.

The computer system 600 may be or include, but is not limited to, one or more of each of the following: a server computer or device, a client computer or device, a personal computer (PC), a tablet, a laptop, a netbook, a set-top box (STB), a personal digital assistant (PDA), an entertainment media system, a cellular telephone, a smartphone, a mobile device, a wearable (e.g., a smartwatch), a smart-home device (e.g., a smart appliance), another smart device (e.g., an Internet of Things (IoT) device), a web appliance, a network router, a network switch, a network bridge, and/or any other machine capable of executing the instructions 602, sequentially or otherwise, that specify actions to be taken by the computer system 600. And while only a single computer system 600 is illustrated, there could just as well be a collection of computer systems that individually or jointly execute the instructions 602 to perform any one or more of the methodologies discussed herein.

As depicted in FIG. 6, the computer system 600 may include processors 604, memory 606, and I/O components 608, which may be configured to communicate with each other via a bus 610. In an example embodiment, the processors 604 (e.g., a central processing unit (CPU), a Reduced Instruction Set Computing (RISC) processor, a Complex Instruction Set Computing (CISC) processor, a graphics processing unit (GPU), a digital signal processor (DSP), an application-specific integrated circuit (ASIC), a radio-frequency integrated circuit (RFIC), another processor, and/or any suitable combination thereof) may include, as examples, a processor 612 and a processor 614 that execute the instructions 602. The term “processor” is intended to include multi-core processors that may include two or more independent processors (sometimes referred to as “cores”) that may execute instructions contemporaneously. Although FIG. 6 shows multiple processors 604, the computer system 600 may include a single processor with a single core, a single processor with multiple cores (e.g., a multi-core processor), multiple processors with a single core, multiple processors with multiples cores, or any combination thereof.

The memory 606, as depicted in FIG. 6, includes a main memory 616, a static memory 618, and a storage unit 620, each of which is accessible to the processors 604 via the bus 610. The memory 606, the static memory 618, and/or the storage unit 620 may store the instructions 602 executable for performing any one or more of the methodologies or functions described herein. The instructions 602 may also or instead reside completely or partially within the main memory 616, within the static memory 618, within machine-readable medium 622 within the storage unit 620, within at least one of the processors 604 (e.g., within a cache memory of a given one of the processors 604), and/or any suitable combination thereof, during execution thereof by the computer system 600. In at least one embodiment, the machine-readable medium 622 includes one or more non-transitory computer-readable storage media.

Furthermore, also as depicted in FIG. 6, I/O components 608 may include a wide variety of components to receive input, produce and/or provide output, transmit information, exchange information, capture measurements, and/or the like. The specific I/O components 608 that are included in a particular instance of the computer system 600 will depend on the type of machine. For example, portable machines such as mobile phones may include a touch input device or other such input mechanisms, while a headless server machine may not include such a touch input device. Moreover, the I/O components 608 may include many other components that are not shown in FIG. 6.

In various example embodiments, the I/O components 608 may include input components 632 and output components 634. The input components 632 may include alphanumeric input components (e.g., a keyboard, a touchscreen configured to receive alphanumeric input, a photo-optical keyboard, and/or other alphanumeric input components), pointing-based input components (e.g., a mouse, a touchpad, a trackball, a joystick, a motion sensor, and/or one or more other pointing-based input components), tactile input components (e.g., a physical button, a touchscreen that is responsive to location and/or force of touches or touch gestures, and/or one or more other tactile input components), audio input components (e.g., a microphone), and/or the like. The output components 634 may include visual components (e.g., a display such as a plasma display panel (PDP), a light emitting diode (LED) display, a liquid crystal display (LCD), a projector, and/or a cathode ray tube (CRT)), acoustic components (e.g., speakers), haptic components (e.g., a vibratory motor, resistance mechanisms), other signal generators, and so forth.

In further example embodiments, the I/O components 608 may include, as examples, biometric components 636, motion components 638, environmental components 640, and/or position components 642, among a wide array of possible components. As examples, the biometric components 636 may include components to detect expressions (e.g., hand expressions, facial expressions, vocal expressions, body gestures, eye tracking, and/or the like), measure biosignals (e.g., blood pressure, heart rate, body temperature, perspiration, brain waves, and/or the like), identify a person (by way of, e.g., voice identification, retinal identification, facial identification, fingerprint identification, electroencephalogram-based identification and/or the like), etc. The motion components 638 may include acceleration-sensing components (e.g., an accelerometer), gravitation-sensing components, rotation-sensing components (e.g., a gyroscope), and/or the like.

The environmental components 640 may include, as examples, illumination-sensing components (e.g., a photometer), temperature-sensing components (e.g., one or more thermometers), humidity-sensing components, pressure-sensing components (e.g., a barometer), acoustic-sensing components (e.g., one or more microphones), proximity-sensing components (e.g., infrared sensors, millimeter-(mm)-wave radar) to detect nearby objects), gas-sensing components (e.g., gas-detection sensors to detect concentrations of hazardous gases for safety and/or to measure pollutants in the atmosphere), and/or other components that may provide indications, measurements, signals, and/or the like that correspond to a surrounding physical environment. The position components 642 may include location-sensing components (e.g., a Global Navigation Satellite System (GNSS) receiver such as a Global Positioning System (GPS) receiver), altitude-sensing components (e.g., altimeters and/or barometers that detect air pressure from which altitude may be derived), orientation-sensing components (e.g., magnetometers), and/or the like.

Communication may be implemented using a wide variety of technologies. The I/O components 608 may further include communication components 644 operable to communicatively couple the computer system 600 to one or more networks 624 and/or one or more devices 626 via a coupling 628 and/or a coupling 630, respectively. For example, the communication components 644 may include a network-interface component or another suitable device to interface with a given network 624. In further examples, the communication components 644 may include wired-communication components, wireless-communication components, cellular-communication components, Near Field Communication (NFC) components, Bluetooth (e.g., Bluetooth Low Energy) components, Wi-Fi components, and/or other communication components to provide communication via one or more other modalities. The devices 626 may include one or more other machines and/or any of a wide variety of peripheral devices (e.g., a peripheral device coupled via a universal serial bus (USB) connection).

Moreover, the communication components 644 may detect identifiers or include components operable to detect identifiers. For example, the communication components 644 may include radio frequency identification (RFID) tag reader components, NFC-smart-tag detection components, optical-reader components (e.g., an optical sensor to detect one-dimensional bar codes such as Universal Product Code (UPC) bar codes, multi-dimensional bar codes such as Quick Response (QR) codes, Aztec codes, Data Matrix, Dataglyph, MaxiCode, PDF417, Ultra Code, UCC RSS-2D bar codes, and/or other optical codes), and/or acoustic-detection components (e.g., microphones to identify tagged audio signals). In addition, a variety of information may be derived via the communication components 644, such as location via IP geolocation, location via Wi-Fi signal triangulation, location via detecting an NFC beacon signal that may indicate a particular location, and/or the like.

One or more of the various memories (e.g., the memory 606, the main memory 616, the static memory 618, and/or the (e.g., cache) memory of one or more of the processors 604) and/or the storage unit 620 may store one or more sets of instructions (e.g., software) and/or data structures embodying or used by any one or more of the methodologies or functions described herein. These instructions (e.g., the instructions 602), when executed by one or more of the processors 604, cause performance of various operations to implement various embodiments of the present disclosure.

The instructions 602 may be transmitted or received over one or more networks 624 using a transmission medium, via a network-interface device (e.g., a network-interface component included in the communication components 644), and using any one of a number of transfer protocols (e.g., the Session Initiation Protocol (SIP), the HyperText Transfer Protocol (HTTP), and/or the like). Similarly, the instructions 602 may be transmitted or received using a transmission medium via the coupling 630 (e.g., a peer-to-peer coupling) to one or more devices 626. In some embodiments, IoT devices can communicate using Message Queuing Telemetry Transport (MQTT) messaging, which can be relatively more compact and efficient.

In view of the disclosure above, a listing of various examples of embodiments is set forth below. It should be noted that one or more features of an example, taken in isolation or combination, should be considered to be within the disclosure of this application.

Example 1 is a method performed by a provisioning server, the method including: receiving a request, associated with a secure device, for a homomorphically encrypted diversified key that is based on a first master key of an encryption system, the secure device storing a secure-device copy of a first homomorphic-encryption key; deriving a first homomorphically encrypted diversified key from a first homomorphically encrypted master key, the first homomorphically encrypted master key being the first master key previously encrypted with the first homomorphic-encryption key; and transmitting the first homomorphically encrypted diversified key to the secure device.

Example 2 is the method of Example 1, where: the request includes an identifier of the first homomorphically encrypted master key; and the method further includes using the identifier of the first homomorphically encrypted master key to retrieve the first homomorphically encrypted master key from a database.

Example 3 is the method of Example 2, where: the secure device further stores (i) a first master-key identifier corresponding to the first master key and (ii) a first homomorphic-key identifier corresponding to the first homomorphic key; the identifier of the first homomorphically encrypted master key includes the first master-key identifier and the first homomorphic-key identifier; and using the identifier of the first homomorphically encrypted master key to retrieve the first homomorphically encrypted master key from the database includes using a combination of the first master-key identifier and the first homomorphic-key identifier to retrieve the first homomorphically encrypted master key from the database.

Example 4 is the method of any of the Examples 1-3, where: the request further includes a diversification value; and deriving the first homomorphically encrypted diversified key from the first homomorphically encrypted master key includes using the diversification value to derive the first homomorphically encrypted diversified key from the first homomorphically encrypted master key.

Example 5 is the method of any of the Examples 1-4, further including using a hardware security module to verify an integrity of the request.

Example 6 is the method of any of the Examples 1-5, where the secure device is configured to, after receiving the first homomorphically encrypted diversified key from the provisioning server: use the secure-device copy of the first homomorphic-encryption key to decrypt the first homomorphically encrypted diversified key, resulting in a first diversified master key; and encode the first diversified master key on the secure device.

Example 7 is the method of Example 6, where, after the encoding, the secure device is operable to use the first diversified master key for access to at least one resource.

Example 8 is a provisioning server including: at least one hardware processor; and one or more non-transitory computer readable storage media containing instructions that, when executed by the at least one hardware processor, cause the provisioning server to perform operations including: receiving a request, associated with a secure device, for a homomorphically encrypted diversified key that is based on a first master key of an encryption system, the secure device storing a secure-device copy of a first homomorphic-encryption key; deriving a first homomorphically encrypted diversified key from a first homomorphically encrypted master key, the first homomorphically encrypted master key being the first master key previously encrypted with the first homomorphic-encryption key; and transmitting the first homomorphically encrypted diversified key to the secure device.

Example 9 is the provisioning server of Example 8, where: the request includes an identifier of the first homomorphically encrypted master key; and the operations further include using the identifier of the first homomorphically encrypted master key to retrieve the first homomorphically encrypted master key from a database.

Example 10 is the provisioning server of Example 9, where: the secure device further stores (i) a first master-key identifier corresponding to the first master key and (ii) a first homomorphic-key identifier corresponding to the first homomorphic key; the identifier of the first homomorphically encrypted master key includes the first master-key identifier and the first homomorphic-key identifier; and using the identifier of the first homomorphically encrypted master key to retrieve the first homomorphically encrypted master key from the database includes using a combination of the first master-key identifier and the first homomorphic-key identifier to retrieve the first homomorphically encrypted master key from the database.

Example 11 is the provisioning server of any of the Examples 8-10, where: the request further includes a diversification value; and deriving the first homomorphically encrypted diversified key from the first homomorphically encrypted master key includes using the diversification value to derive the first homomorphically encrypted diversified key from the first homomorphically encrypted master key.

Example 12 is the provisioning server of any of the Examples 8-11, the operations further including using a hardware security module to verify an integrity of the request.

Example 13 is the provisioning server of any of the Examples 8-12, where the secure device is configured to, after receiving the first homomorphically encrypted diversified key from the provisioning server: use the secure-device copy of the first homomorphic-encryption key to decrypt the first homomorphically encrypted diversified key, resulting in a first diversified master key; and encode the first diversified master key on the secure device.

Example 14 is the provisioning server of Example 13, where, after the encoding, the secure device is operable to use the first diversified master key for access to at least one resource.

Example 15 is one or more non-transitory computer readable storage media containing instructions that, when executed by at least one hardware processor of a provisioning server, cause the provisioning server to perform operations including: receiving a request, associated with a secure device, for a homomorphically encrypted diversified key that is based on a first master key of an encryption system, the secure device storing a secure-device copy of a first homomorphic-encryption key; deriving a first homomorphically encrypted diversified key from a first homomorphically encrypted master key, the first homomorphically encrypted master key being the first master key previously encrypted with the first homomorphic-encryption key; and transmitting the first homomorphically encrypted diversified key to the secure device.

Example 16 is the one or more non-transitory computer readable storage media of Example 15, where: the request includes an identifier of the first homomorphically encrypted master key; and the operations further include using the identifier of the first homomorphically encrypted master key to retrieve the first homomorphically encrypted master key from a database.

Example 17 is the one or more non-transitory computer readable storage media of Example 16, where: the secure device further stores (i) a first master-key identifier corresponding to the first master key and (ii) a first homomorphic-key identifier corresponding to the first homomorphic key; the identifier of the first homomorphically encrypted master key includes the first master-key identifier and the first homomorphic-key identifier; and using the identifier of the first homomorphically encrypted master key to retrieve the first homomorphically encrypted master key from the database includes using a combination of the first master-key identifier and the first homomorphic-key identifier to retrieve the first homomorphically encrypted master key from the database.

Example 18 is the one or more non-transitory computer readable storage media of any of the Examples 15-17, where: the request further includes a diversification value; and deriving the first homomorphically encrypted diversified key from the first homomorphically encrypted master key includes using the diversification value to derive the first homomorphically encrypted diversified key from the first homomorphically encrypted master key.

Example 19 is the one or more non-transitory computer readable storage media of any of the Examples 15-18, the operations further including using a hardware security module to verify an integrity of the request.

Example 20 is the one or more non-transitory computer readable storage media of any of the Examples 15-19, where the secure device is configured to, after receiving the first homomorphically encrypted diversified key from the provisioning server: use the secure-device copy of the first homomorphic-encryption key to decrypt the first homomorphically encrypted diversified key, resulting in a first diversified master key; and encode the first diversified master key on the secure device.

Example 21 is the one or more non-transitory computer readable storage media of Example 20, where, after the encoding, the secure device is operable to use the first diversified master key for access to at least one resource.

Furthermore, in this disclosure, in one or more embodiments, examples, and/or the like, it may be the case that one or more components of one or more devices, systems, and/or the like are referred to as modules that carry out (e.g., perform, execute, and the like) various functions. With respect to any such usages in the present disclosure, a module includes both hardware and instructions. The hardware could include one or more processors, one or more microprocessors, one or more microcontrollers, one or more microchips, one or more application-specific integrated circuits (ASICs), one or more field programmable gate arrays (FPGAs), one or more graphical processing units (GPUs), one or more tensor processing units (TPUs), and/or one or more devices and/or components of any other type deemed suitable by those of skill in the art for a given implementation.

In at least one embodiment, the instructions for a given module are executable by the hardware for carrying out the one or more herein-described functions of the module, and could include hardware (e.g., hardwired) instructions, firmware instructions, software instructions, and/or the like, stored in any one or more non-transitory computer-readable storage media deemed suitable by those of skill in the art for a given implementation. Each such non-transitory computer-readable storage medium could be or include memory (e.g., random access memory (RAM), read-only memory (ROM), erasable programmable read-only memory (EPROM), electrically erasable programmable read-only memory (EEPROM a.k.a. E2PROM), flash memory, and/or one or more other types of memory) and/or one or more other types of non-transitory computer-readable storage medium. A module could be realized as a single component or be distributed across multiple components. In some cases, a module may be referred to as a unit.

Moreover, consistent with the fact that the entities and arrangements that are described herein, including the entities and arrangements that are depicted in and described in connection with the drawings, are presented as examples and not by way of limitation, any and all statements or other indications as to what a particular drawing “depicts,” what a particular element or entity in a particular drawing or otherwise mentioned in this disclosure “is” or “has,” and any and all similar statements that are not explicitly self-qualifying by way of a clause such as “In at least one embodiment,” and that could therefore be read in isolation and out of context as absolute and thus as a limitation on all embodiments, can only properly be read as being constructively qualified by such a clause. It is for reasons akin to brevity and clarity of presentation that this implied qualifying clause is not repeated ad nauseum in this disclosure.

1. A method performed by a provisioning server, the method comprising:
receiving a request, associated with a secure device, for a homomorphically encrypted diversified key that is based on a first master key of an encryption system, the secure device storing a secure-device copy of a first homomorphic-encryption key;
deriving a first homomorphically encrypted diversified key from a first homomorphically encrypted master key, the first homomorphically encrypted master key being the first master key previously encrypted with the first homomorphic-encryption key; and
transmitting the first homomorphically encrypted diversified key to the secure device.

2. The method of claim 1, wherein:
the request comprises an identifier of the first homomorphically encrypted master key; and
the method further comprises using the identifier of the first homomorphically encrypted master key to retrieve the first homomorphically encrypted master key from a database.

3. The method of claim 2, wherein:
the secure device further stores (i) a first master-key identifier corresponding to the first master key and (ii) a first homomorphic-key identifier corresponding to the first homomorphic key;
the identifier of the first homomorphically encrypted master key comprises the first master-key identifier and the first homomorphic-key identifier; and
using the identifier of the first homomorphically encrypted master key to retrieve the first homomorphically encrypted master key from the database comprises using a combination of the first master-key identifier and the first homomorphic-key identifier to retrieve the first homomorphically encrypted master key from the database.

4. The method of claim 1, wherein:
the request further comprises a diversification value; and
deriving the first homomorphically encrypted diversified key from the first homomorphically encrypted master key comprises using the diversification value to derive the first homomorphically encrypted diversified key from the first homomorphically encrypted master key.

5. The method of claim 1, further comprising using a hardware security module to verify an integrity of the request.

6. The method of claim 1, wherein the secure device is configured to, after receiving the first homomorphically encrypted diversified key from the provisioning server:
use the secure-device copy of the first homomorphic-encryption key to decrypt the first homomorphically encrypted diversified key, resulting in a first diversified master key; and
encode the first diversified master key on the secure device.

7. The method of claim 6, wherein, after the encoding, the secure device is operable to use the first diversified master key for access to at least one resource.

8. A provisioning server comprising:
at least one hardware processor; and
one or more non-transitory computer readable storage media containing instructions that, when executed by the at least one hardware processor, cause the provisioning server to perform operations comprising:
receiving a request, associated with a secure device, for a homomorphically encrypted diversified key that is based on a first master key of an encryption system, the secure device storing a secure-device copy of a first homomorphic-encryption key;
deriving a first homomorphically encrypted diversified key from a first homomorphically encrypted master key, the first homomorphically encrypted master key being the first master key previously encrypted with the first homomorphic-encryption key; and
transmitting the first homomorphically encrypted diversified key to the secure device.

9. The provisioning server of claim 8, wherein:
the request comprises an identifier of the first homomorphically encrypted master key; and
the operations further comprise using the identifier of the first homomorphically encrypted master key to retrieve the first homomorphically encrypted master key from a database.

10. The provisioning server of claim 9, wherein:
the secure device further stores (i) a first master-key identifier corresponding to the first master key and (ii) a first homomorphic-key identifier corresponding to the first homomorphic key;
the identifier of the first homomorphically encrypted master key comprises the first master-key identifier and the first homomorphic-key identifier; and
using the identifier of the first homomorphically encrypted master key to retrieve the first homomorphically encrypted master key from the database comprises using a combination of the first master-key identifier and the first homomorphic-key identifier to retrieve the first homomorphically encrypted master key from the database.

11. The provisioning server of claim 8, wherein:
the request further comprises a diversification value; and
deriving the first homomorphically encrypted diversified key from the first homomorphically encrypted master key comprises using the diversification value to derive the first homomorphically encrypted diversified key from the first homomorphically encrypted master key.

12. The provisioning server of claim 8, the operations further comprising using a hardware security module to verify an integrity of the request.

13. The provisioning server of claim 8, wherein the secure device is configured to, after receiving the first homomorphically encrypted diversified key from the provisioning server:
use the secure-device copy of the first homomorphic-encryption key to decrypt the first homomorphically encrypted diversified key, resulting in a first diversified master key; and
encode the first diversified master key on the secure device.

14. The provisioning server of claim 13, wherein, after the encoding, the secure device is operable to use the first diversified master key for access to at least one resource.

15. One or more non-transitory computer readable storage media containing instructions that, when executed by at least one hardware processor of a provisioning server, cause the provisioning server to perform operations comprising:
receiving a request, associated with a secure device, for a homomorphically encrypted diversified key that is based on a first master key of an encryption system, the secure device storing a secure-device copy of a first homomorphic-encryption key;
deriving a first homomorphically encrypted diversified key from a first homomorphically encrypted master key, the first homomorphically encrypted master key being the first master key previously encrypted with the first homomorphic-encryption key; and
transmitting the first homomorphically encrypted diversified key to the secure device.

16. The one or more non-transitory computer readable storage media of claim 15, wherein:
the request comprises an identifier of the first homomorphically encrypted master key; and
the operations further comprise using the identifier of the first homomorphically encrypted master key to retrieve the first homomorphically encrypted master key from a database.

17. The one or more non-transitory computer readable storage media of claim 16, wherein:
the secure device further stores (i) a first master-key identifier corresponding to the first master key and (ii) a first homomorphic-key identifier corresponding to the first homomorphic key;
the identifier of the first homomorphically encrypted master key comprises the first master-key identifier and the first homomorphic-key identifier; and
using the identifier of the first homomorphically encrypted master key to retrieve the first homomorphically encrypted master key from the database comprises using a combination of the first master-key identifier and the first homomorphic-key identifier to retrieve the first homomorphically encrypted master key from the database.

18. The one or more non-transitory computer readable storage media of claim 15, wherein:
the request further comprises a diversification value; and
deriving the first homomorphically encrypted diversified key from the first homomorphically encrypted master key comprises using the diversification value to derive the first homomorphically encrypted diversified key from the first homomorphically encrypted master key.

19. (canceled)

20. The one or more non-transitory computer readable storage media of claim 15, wherein the secure device is configured to, after receiving the first homomorphically encrypted diversified key from the provisioning server:
use the secure-device copy of the first homomorphic-encryption key to decrypt the first homomorphically encrypted diversified key, resulting in a first diversified master key; and
encode the first diversified master key on the secure device.

21. The one or more non-transitory computer readable storage media of claim 20, wherein, after the encoding, the secure device is operable to use the first diversified master key for access to at least one resource.
